(19) United States
(12) Patent Application Publication
(10) Pub. No.: US 2005/0041725 A1
(43) Pub. Date: Feb. 24, 2005

(54) Receiver of an ultra wide band signal and associated reception method

(75) Inventors: Sebastien De Rivaz, Chambery (FR); Dominique Morche, Meylan (FR); Manuel Pezzin, Grenoble (FR); Julien Keignart, Gieres (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 10/847,361

(22) Filed: May 18, 2004

(30) Foreign Application Priority Data
May 26, 2003 (FR) 03 50175

(51) Int. Cl. H04K 1/00; H04B 1/69; H04B 1/707; H04B 1/713; H04B 15/00; H04L 27/30

(52) U.S. Cl. 375/150; 375/132

(57) ABSTRACT

This invention relates to a receiver of an ultra wide band signal and the associated method. The receiver comprises:
means (7) of outputting two orthogonal signals by projection of the received signal (R(t)) onto two periodic orthogonal functions with frequency approximately equal to the central frequency of the received signal,
sampling means (7) of two orthogonal signals to output a discrete data stream (X(k), Y(k)) with two components,
estimating means (8) for calculating a reference signal starting from the discrete data stream with two dimensions, and
comparison means (9) for comparing all or some of the data contained in the discrete data stream with all or part of the data forming the reference signal. The invention is applicable to high-speed transmissions and positioning of transmitters/receivers.

### TECHNICAL FIELD AND PRIOR ART

The invention relates to a receiver of an ultra wide band signal and a method for reception of an ultra wide band signal.

The invention also relates to an ultra wide band transmission system and a method for transmission of an ultra wide band signal.

Transmission of information by ultra wide band radio pulses, more frequently known as UWB (Ultra Wide Band) transmission, is applicable to various types of transmissions including high speed transmissions, for example between 1 Mbit/s and 1 Gbit/s, and transmitter/receiver positioning (radar and telecommunications applications). The bandwidth B of transmitted signals can vary, for example, from 500 Mz to several Gigahertz.

An ultra wide band transmission system emits pulse sequences with an average transmission period usually called the PRP (Pulse Repetition Period), and for which the position and/or amplitude and/or phase carry information. When the information is position modulated, the term PPM (Pulse Position Modulation) is used.

A UWB transmission system is shown in FIG. 1. The system includes transmission circuits and reception circuits. Transmission circuits include a pulse generator 1, a radiofrequency transmission interface 2 (Tx Front-end) and an antenna 3. Pulses Ie are transmitted under the action of set values C applied to the pulse generator 1. Reception circuits include an antenna 4, a radiofrequency reception interface 5 (Rx Front-end) and a receiver 6. The propagation channel in which transmitted pulses Ie propagate is located between the transmission circuits and the reception circuits.

FIG. 2 shows the positions in time and the corresponding amplitudes of a set value signal C, a pulse Ie transmitted under the action of the set value signal C and the received signal R(t) corresponding to the transmitted pulse Ie. The transmission channel effect is applied to the transmitted pulse Ie. This effect is modeled by a series of multiple reflections that depend on the geometric configuration of the propagation environment. This results in spreading of the received signal R(t) in the form of a sequence of weighted pulses, for which the position and amplitude depend on the channel.

More generally, the transmitted signal is composed of a sequence of constant “physical” pulses. The transmitted pulses are said to be “physical” because they have a particular shape and a non-zero width L depending on the passband B used for the communication, and where L is approximately equal to 1/B. On the other hand, “ideal” pulses or Dirac pulses are zero width pulses. Pulses are transmitted by the pulse generator 1, with pulse response e(t), that receives the set value signals C. The signal transmitted by the pulse generator 1, in other words the sequence of physical pulses transmitted by the pulse generator 1, is affected by the interfaces (amplifiers, filters, etc.) of the transmission antenna 3 and the propagation channel assumed to be quasi constant.

The received signal R(t) is composed of a sequence of very short width weighted pulses for which the position and amplitude are determined by the transmitter and the transmission channel. The signal R(t) can thus be modeled by a deterministic element that results from convolution of the signal e(t) with the pulse response h(t) of the channel. The response h(t) of the channel should be understood in the broad sense of the term, in other words including radiofrequency components (radiofrequency interfaces and transmission and reception antennas) and the propagation channel.

There is a relation:

R(t)=e(t)\mathring{×}h(t) where the symbol \mathring{×} denotes the “convolution product” operation.

Received pulse responses corresponding to two different transmitted pulses may overlap when the duration separating the transmission of the two pulses is less than the spread of pulse responses. A random element i(t) representing electromagnetic interference and/or thermal interference, and variations on the function h(t), can also be added to the time overlap between pulses.

The transmission set value is a sequence of periodically repeated pulses C. The pulse repetition period PRP provides a time reference for the transmission/reception system.

Transmission of information is based on a position and/or amplitude and/or phase modulation of the transmitted pulses. The position modulation is thus obtained by a time offset of the transmitted pulse with respect to a time reference. Amplitude modulation is obtained by applying a coefficient to the amplitude of a reference pulse. Phase modulation is obtained by a modification to the shape of the transmitted pulse.

Transmission of a modulated or unmodulated pulse forms a physical frame on reception that is referenced to a nominal position in time (beginning of the PRP period) and to nominal reference amplitude. A “physical frame” means the signal received by the receiver in a time window, for which the duration is equal to the sum of the maximum spreading duration of received pulse responses and the maximum duration of the position modulation.

An ultra wide band transmission phase requires an initialization phase for which the main function is to synchronize the physical frames, in other words to determine knowledge of the arrival time of each physical frame. This arrival time corresponds to nominal instants of the PRP period offset in time by the propagation delay due to the channel.

When the propagation channel is minimal, in other words it is a Line of Sight (LOS) type path, the localized shape of the received UWB pulse is very narrow in time and its width is Tp=1/B (where B is the band width of the received pulse), for example it may only last a few hundred picoseconds.

In a more general propagation configuration, of the Non-Line of Sight (NLOS) path type, the signal is spread over a duration longer than the duration of its initial time width, in the form of a sequence of weighted pulses. Note that while each path individually can vary in position and in amplitude fairly quickly, the spread signal as a whole remains relatively constant.

Different problems that occur with ultra wide band receivers will now be described.

A first problem is due to the precise position in time of the received pulses. Precise knowledge of the received pulse reduces the required processing capacity of the receiver, since in this case there is no need to extract information from where it is known to be absent. This point may be very important in terms of physical feasibility. Precise knowledge of the position of each Non-Line of Sight type propagation path in time is thus required.

A second problem is to maintain an optimum Signal to Noise Ratio (SNR). It is important to retrieve the maximum energy from the transmitted signal that is dispersed in time by the propagation channel. Therefore, the propagation channel estimate must be robust in terms of channel changes.

The third problem consists of precisely determining weighting coefficients of each path. Consequently, at the moment there is a wide consensus between UWB transmission developers to make use of knowledge about the pulse response of the channel. Thus most existing solutions use the principle of filtering of the received signal using a signal that is itself output from the received signal. Precise knowledge of the amplitude of multi-paths is necessary in addition to precise knowledge of positions of multi-paths in time, to optimize filtering in the sense of a Maximum Ratio Combining (MRC). The objective is then to assign a weighting corresponding to each multi-path in the signal to be demodulated, to avoid degrading the SNR. An ideal filter is thus a filter that makes use of all paths with an infinite accuracy in time and knowledge of weighting with infinite precision.

Filtering consists of correlating the received signal with a reference signal that is an image of the pulse response of the channel. Most existing solutions make use of two main variants of this filtering principle.

A first variant is based on a differential type processing. A received pulse is then multiplied by the previous delayed pulse and is integrated over the duration of its spreading. In the situation of a signal with no noise or little noise, the shape of the current signal and the delayed signal are then the same. The operation approaches an adapted ideal filtering, in the sense of Maximum Ratio Combining (MRC), since the ideal filter would be the filter for which the coefficients are the signal itself. However, in the more realistic situation of a noisy signal, the SNR degrades quickly as soon as the noise on the output side of the processing increases since the filter coefficients are largely degraded.

A second variant advantageously eliminates dependence on noise in the correlation signal. The channel estimate is analyzed later and in parallel to remove noise from it to produce a reference signal for the correlation.

Receiver architectures and the associated processing must then be capable of both estimating the channel and comparing the received signal with a reference signal in order to extract the modulation information from it.

U.S. Pat. No. 2002/0075972 A1 discloses an embodiment of this second variant. The channel estimate is made by detecting the maximum possible number of multi-paths in position and in amplitude. The precision of the estimate in time respects the Nyquist criterion, in other words it is less than or equal to half of the inverse of the passband of the signal. Since the positions of the multi-paths are known, samples of the received signal are taken at clearly defined appropriate instants. This sampling is done by a RAKE type receiver that uses high-level parallelism. In order to improve the global gain of the processing, sampling is preceded by filtering adapted to the shape of the pulse, which assumes that this shape is known a priori. One disadvantage of this filtering is that the shape of the received pulse does not necessarily comply with the expected pulse due to modifications caused by imperfections of components through which the signal passes. The channel estimate is made by searching for multi-paths, and knowledge of these multi-paths forms the reference signal for the correlation.

Another disadvantage of the receiver divulged in U.S. Pat. No. 2002/0075972 is the need to put a large number of reception circuits of the radiofrequency interface in parallel, which leads to high electrical consumption and complex electronic circuits.

There are two reasons for the need to put in parallel in this way. Firstly, the reception function has to be duplicated in two physical sub-functions, one scanning multi-paths and the other tracking the current received signal. Furthermore, in the case of an N-Pulse Position Modulation (N-PPM), it is necessary to track the modulation positions for which nominal values are determined and distributed on a discrete scale and multi-path positions which, although known due to scanning, are distributed at random on a continuous time scale, in the same time windows. The result is necessary duplication of the reception circuits.

The document entitled “An Integrated, Low Power, Ultra-Wideband Transceiver Architecture For Low-Rate, Indoor Wireless Systems” (Ian D. O'Donnell, Mikes S. W. Chen, Stanley B. T. Wang, Robert W. Brodersen; IEEE CAS Workshop on Wireless Communications and Networking; Pasadena, Sep. 4-5^{th} 2002) illustrates another embodiment of this second variant. However, note that the solution proposed in this case is limited to direct processing in a relatively narrow baseband (0-1 GHz) and transmission of low throughputs. Processing is done in “all digital”. The channel estimate is made by digital processing of signals sampled at the Nyquist frequency, which is twice the passband. Typically, this processing consists of taking the average of the signal received cyclically on several successive pulses.

The solutions mentioned above have many disadvantages (sampling at high frequency, high consumption, mediocre signal to noise ratio, etc.). The invention does not have the disadvantages mentioned above.

### PRESENTATION OF THE INVENTION

The invention actually relates to a receiver of an ultra wide band signal (R(t)) composed of a sequence of pulses, the receiver including means of outputting amplitude information (Va) and/or phase information (Vφ) related to the received pulses, by correlation of the received signal (R(t)) with a reference signal (ref (k)) characterized in that the said means comprise:
means of outputting two orthogonal signals by projection of the received signal (R(t)) onto two periodic orthogonal functions (a, b) with frequency fp approximately equal to the central frequency fc of the received signal,
sampling means of the two orthogonal signals to output a discrete data stream (d(k)), each discrete data having two components (X(k), Y(k)),
estimating means for calculating the reference signal (ref (k)) starting from the discrete data stream (d(k)), and
comparison means that output amplitude information (Va) and/or phase information (Vφ) related to received pulses by comparing all or some of the data contained in the discrete data stream (d(k)) with all or part of a set of data (Xr(0), Xr(l), . . . , Xr(n), Yr(0), Yr(1), . . . , Yr(n)) forming the reference signal (ref (k)).

According to another characteristic of the invention, the receiver comprises a coherent decoding and integration circuit to reduce discrete data (d(k)) noise output by the sampling means.

According to yet another characteristic of the invention, the comparison means include finite pulse response filter banks for which the coefficients are data that form the reference signal (ref (k)).

According to yet another characteristic of the invention, the receiver comprises low pass filters placed between the means of outputting the two orthogonal signals and sampling means, and for which the cutoff frequency is equal to approximately half the band width of the received signal (R(t)).

According to yet another characteristic of the invention, the low pass filters (15, 16) are equalizer filters.

According to yet another characteristic of the invention, the sampling frequency of the sampling means is equal to approximately fp/K3, where K3 is a rational number.

According to yet another characteristic of the invention, the sampling means are non-periodically controlled.

According to yet another characteristic of the invention, the estimating means for calculating the reference signal (ref (k)) calculate a coherent average on the physical frames of the received signal.

According to yet another characteristic of the invention, the receiver comprises at least one band cutoff filter placed on the input side of the means of outputting the two orthogonal signals and for which the central frequency is within the passband of the received signal (R(t)).

According to yet another characteristic of the invention, at least one band cutoff filter is centered on the central frequency fc of the received signal.

According to yet another characteristic of the invention, the receiver comprises a signal detection circuit that calculates a norm with at least one discrete data (d(k)) and a decision stage mounted in series with the detection circuit to decide whether or not to process the received signal associated with the discrete data.

According to yet another characteristic of the invention, the norm is equal to the square of the modulus of the two components (X(k), Y(k)) of the discrete data.

According to yet another characteristic of the invention, the norm is equal to the maximum of the two components (X(k), Y(k)) of the discrete data.

According to yet another characteristic of the invention, the receiver comprises a slaving loop that transmits phase information (Vφ) as the control signal for a receiver clock circuit.

According to another characteristic of the invention, the receiver clock circuit outputs the two periodic orthogonal functions (a, b) with frequency fp.

The invention also relates to an ultra wide band transmission system comprising a transmitter that transmits pulse sequences, a receiver and a transmission channel between the transmitter and the receiver. The receiver is a receiver according to the invention as mentioned above.

According to yet another characteristic of the invention, the average period of the transmitted pulses is equal to K1/fp, where K1 is a real number.

According to yet another characteristic of the invention, K1 is an integer number greater than or equal to 1.

According to another characteristic of the invention, the time base for the position modulation of the transmitted pulses is equal to approximately K2/fp, where K2 is a real number.

According to yet another characteristic of the invention, K2 is an integer number greater than or equal to 1.

The invention also relates to a method for reception of an ultra wide band signal (R(t)) composed of a sequence of pulses, the method being used to output amplitude information (Va) and/or phase information (Vφ) related to received pulses, by correlation of the received signal (R(t)) with a reference signal (ref(k)). The reception method includes:
a step for projection of a received signal (R(t)) on two periodic orthogonal functions (a, b) with frequency fp equal to approximately the central frequency fc of the received signal, to output two orthogonal signals,
a sampling step for the two orthogonal signals to output a discrete data stream (d(k)), each discrete data having two components (X(k), Y(k)),
an estimating step to calculate the reference signal (ref(k)) from the discrete data stream (d(k)), and
a comparison step that outputs amplitude information (Va) and/or phase information (Vφ) related to received pulses by comparison of all or some of the data contained in the discrete data stream (d(k)) with all or some of a set of data (Xr(0), Xr(1), . . . , Xr(n), Yr(0), Yr(1), . . . , Yr(n)) forming the reference signal (ref(k)).

According to another characteristic of the invention, the reception method comprises a coherent decoding and integration step to reduce the noise of discrete data (d(k)) output from the sampling step.

According to yet another characteristic of the invention, the reception method includes a low pass filtering step of the two orthogonal signals, the filter bandwidth being equal to approximately the bandwidth of the ultra wide band signal (R(t)).

According to yet another characteristic of the invention, sampling is done at a sampling frequency equal to approximately fp/k3, where K3 is a rational number.

According to yet another characteristic of the invention, sampling is non-periodic.

According to yet another characteristic of the invention, during the estimating step, the reference signal is calculated in the form of a coherent average on physical frames of the ultra wide band signal (R(t)).

According to yet another characteristic of the invention, the reception method includes band cutoff filtering of the ultra wide band signal centered on the frequency fc of the received signal.

According to yet another characteristic of the invention, the central frequency of the band cutoff filtering is controlled by a control circuit that controls the frequency of the two periodic orthogonal functions.

According to yet another characteristic of the invention, the reception method includes the calculation of a norm for at least one discrete data (d(k)) with two dimensions (X(k), Y(k)) and a decision step to decide whether or not the received signal associated with the discrete data should be processed.

According to yet another characteristic of the invention, the method includes a step to slave a clock circuit of the receiver using phase information (Vφ).

The invention also relates to a method for transmission of the ultra wide band signal including a method for transmitting pulse sequences and a method for receiving transmitted pulses, characterized in that the method for reception of transmitted pulses is a method according to the invention as mentioned above.

According to another characteristic of the transmission method according to the invention, the average period of transmitted pulses is equal to K1/fp, where K1 is a real number.

According to yet another characteristic of the transmission method according to the invention, K1 is an integer number greater than or equal to 1.

According to yet another characteristic of the transmission method according to the invention, the time base for position modulation of transmitted pulses is equal to approximately K2/fp, where K2 is a positive real number.

According to yet another characteristic of the method according to the invention, K2 is an integer number greater than or equal to 1.

The method for reception of the ultra wide band signal according to the invention advantageously eliminates the need to scan the channel with high precision.

Advantageously, the channel estimate is made and the received pulses are processed within the same data stream in the reception radiofrequency interface. The invention proposes a processing that directly gives continuous information about the position and/or amplitude and/or phase on each of the multi-paths.

The device according to the invention transposes the received signal into a sequence of complex samples. The complex samples obtained are used to analyze information on the channel, received pulses and synchronization.

Firstly, the channel is acquired. The channel acquisition phase requires that a sequence of pulses known by the receiver a priori should be transmitted. The acquisition consists firstly of obtaining a coarse estimate of the time of arrival of a received pulse (phase synchronization on the pulse sequence mentioned above), and secondly building a reference signal that is the image of the pulse response of the propagation channel, after noise has been removed. The estimated phase and/or amplitude of the current signal provides a means of assuring transmitter/receiver synchronization (control of the clock frequency and/or control of the gain). The reference signal is updated from complex samples, to take account of variation of the propagation channel.

One simple means of building the reference signal is to perform a coherent integration of the received data, frame by frame, on several PRP periods. There are also other methods of building the reference signal, for example such as methods known in estimating theory. As a non-limitative example, an alternative estimate is to use a regressive iterative method (advanced estimating algorithm).

The next step is to make a comparison of the current received signal with the reference signal to extract position and/or amplitude and/or phase information from the current signal. According to one particularly advantageous characteristic of the invention, the position and/or phase information of the current received signal provide a means of detecting frequency synchronization errors, as will be described in more detail later.

Compared with known prior art, some essential advantages of the receiver according to the invention are as follows:
a very significant improvement to the signal to noise ratio (SNR);
a single data stream is used to obtain the position of samples and also to acquire multi-paths;
a reduced sampling rate adapted to the useful passband can reduce consumption, or if consumption remains unchanged, can work faster or within a wider passband.

### BRIEF DESCRIPTION OF THE FIGURES

Other characteristics and advantages of the invention will become clear after reading a preferred embodiment with reference to the attached figures among which:

FIG. 1 shows a principle diagram for an ultra wide band transmission system;

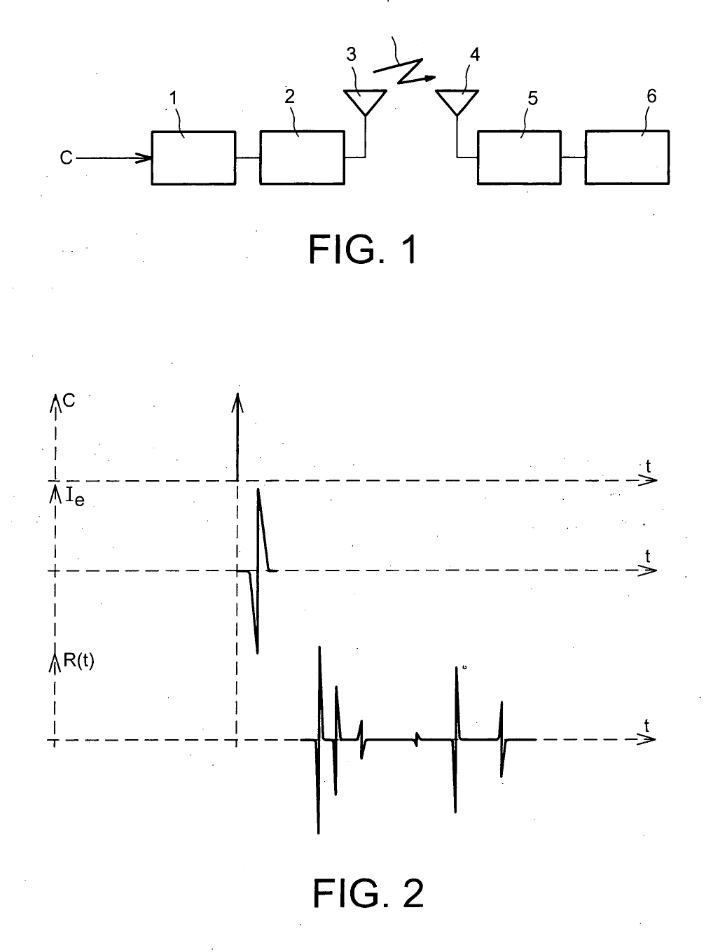

FIG. 2 shows signals transmitted and received in an ultra wide band transmission system;

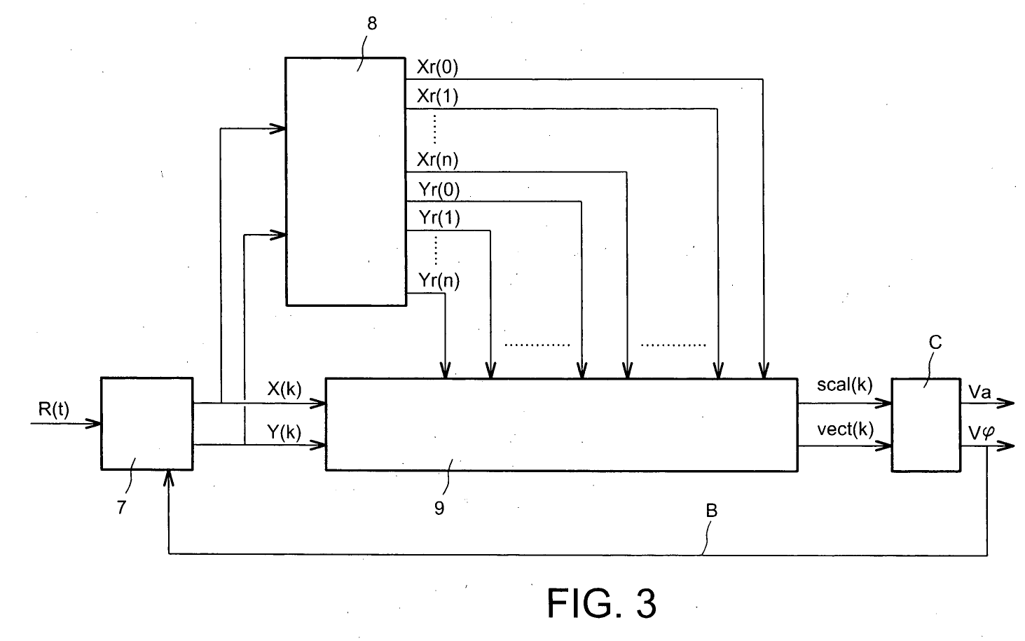

FIG. 3 shows an ultra wide band transmission system receiver according to the preferred embodiment of the invention;

FIG. 4 shows an improvement to the receiver shown in FIG. 3;

FIG. 5 shows a functional diagram of a first circuit shown in FIGS. 3 and 4;

FIGS. 6a-6d show signals used in the circuit shown in FIG. 5;

FIG. 7 shows a functional diagram of a second circuit shown in FIGS. 3 and 4;

FIG. 8 shows a functional diagram of a circuit shown in FIG. 7;

FIGS. 9 and 10 show a first and second improvement to the receiver shown in FIG. 4, respectively.

### DETAILED DESCRIPTION OF EMBODIMENTS OF THE INVENTION

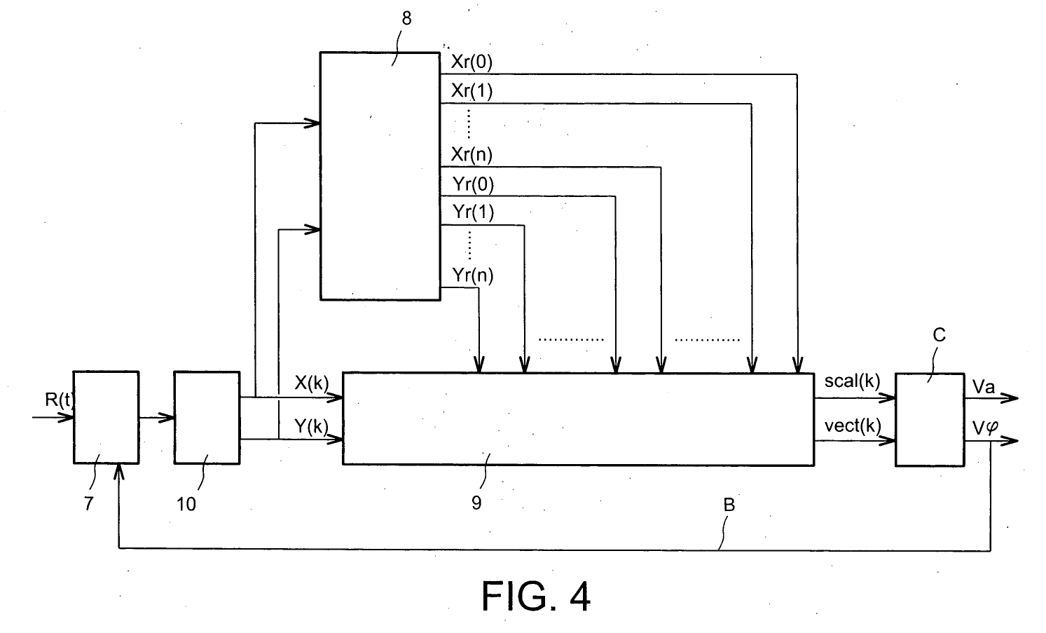

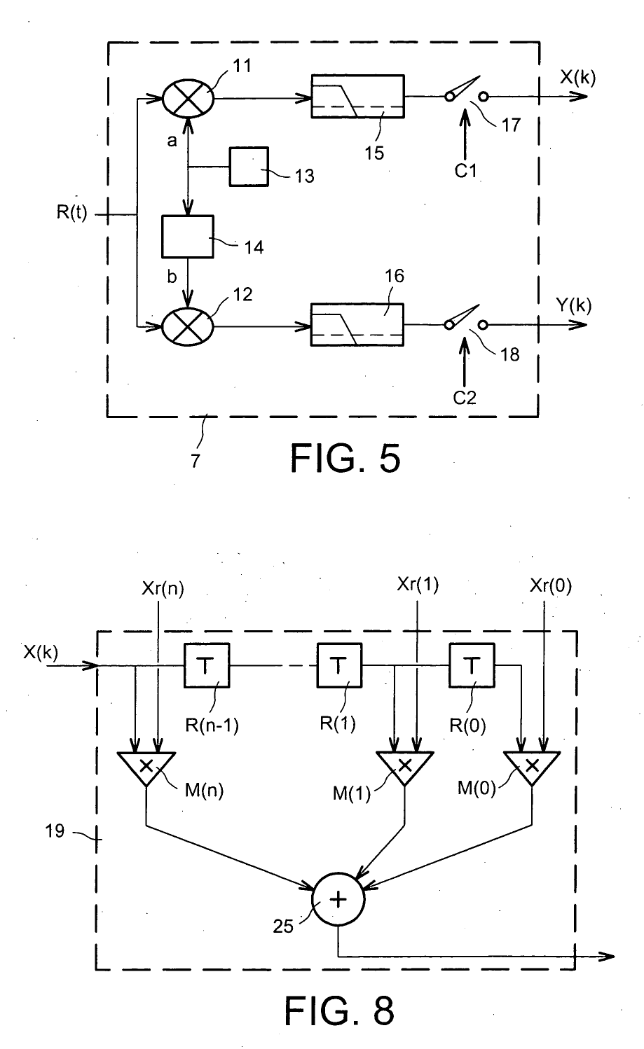

FIG. 3 shows a receiver in an ultra wide band transmission system according to the invention, and FIG. 4 shows an improvement to the receiver shown in FIG. 3.

The receiver according to the invention comprises a time discretization circuit 7 that outputs samples of the received signal, a pulse response estimating circuit 8 that outputs a reference signal starting from the samples output by the circuit 7, a comparison circuit 9 comparing samples output by the circuit 7 and the reference signal output by circuit 8, and a circuit C that uses the signal output by the comparison circuit 9 to calculate position, amplitude and phase information related to the received signal.

According to the improvement shown in FIG. 4, the receiver includes a coherent decoding and integration circuit 10 that has the function of reducing noise from samples output by circuit 7. The circuit 10 in FIG. 4 is placed on the input side of the circuit 9. According to alternative embodiments of the invention, the circuit 10 may be placed at the output from circuit 9 or at the output from circuit C.

The function of the received signal discretization circuit 7 is to project the received signal onto a family of two orthogonal frequency functions fp, and then to sample the signal thus projected. The signal output from the circuit 7 is a data stream d(k) of discrete values with two dimensions X(k), Y(k), the parameter k representing the rank of a sample (k 0, 1, . . . , n). The data stream d(k) corresponds to the sequence of received physical frames, and the said physical frames can overlap.

The function of the pulse response estimating circuit 8 is to build a reference signal ref(k) from the discrete flow d(k). For example, one way of making this estimate may be to take a coherent average on physical frames of the received signal.

The function of the comparison circuit 9 is to compare the discrete image of the current received signal d(k) with the reference signal ref(k) to extract time position and/or amplitude and/or phase information corresponding to the received pulses from this signal. One way of making this comparison is to use filter banks with a finite pulse response (FPR), for which the coefficients are output from the reference signal ref(k) A recombination of signals output by finite pulse response filters can then be used to obtain magnitudes scal(k) and vect(k) such that:
scale(k)=d(k)*ref(k); and
vect(k)=d(k)\hat{ }ref(k),
where the “*” symbol represents the scalar product operation (measurement of correlation) and the “\hat{ }” symbol represents the vector product operation (measurement of orthogonality).

The circuit C uses the magnitudes scal(k) and vect(k) to calculate voltages Va and Vφ representing the amplitude and the phase respectively of the received signal R(t). The amplitude information is used to determine the position of the received signal. The position is thus given, for example, by the maximum amplitude or by detection of an overshoot of the given threshold on the voltages Va. Advantageously, sliding of the receiver clock compared with the transmitter clock can be corrected. The voltage Vφ representing the phase of the received signal is then used as a control signal for the receiver clock, for example that is present in circuit 7.

According to one alternative of the invention, the comparison circuit 9 and the circuit C may be replaced by a processing circuit based on sample polar coordinates X(k) and Y(k), commonly called the CORDIC (COordinate Rotation DIgital Computer) circuit, the said polar coordinate processing circuit outputs the same amplitude and phase information Va, Vφ as that mentioned above.

The transmitted pulses are very narrow, which involves a high time precision requirement for all transmission and reception parameters, and particularly for the average transmission period PRP, the position modulation difference of the transmitted pulses ΔT(PPM), the sampling period T and the frequency fp of orthogonal functions a and b.

The method according to the invention produces and maintains robust synchronization of all these parameters. This synchronization is achieved by maintaining known and fixed ratios K1, K2, K3 such that:
PRP=K1/fp;
ΔT(PPM)=K2/fp;

T=K3/fp, where K1 and K2 are positive real numbers and K3 is a rational number.

These ratios are kept constant by the voltage Vφ that outputs regular information about any phase slip, through the slaving loop B.

Note that if the coefficient K1 is not integer, a different phase corresponds to each period PRP on each of the complex samples, and this phase then has to be calculated in base band, as a function of knowledge of K1, and has to be taken into account for filtering done by the comparison circuit 9.

According to one advantageous mode of the invention, the coefficient K1 is an integer number greater than or equal to 1. In this case, there is a given phase on the received pulse that corresponds to a given nominal position within a period PRP (i.e. for a constant relative period with respect to the beginning of the period PRP) and with a given phase on the transmitted pulse taking a limited number of discrete values that only depend on the modulation on the phase. In this case, if there is no sliding of the transmitter/receiver clocks and for a given nominal position within a PRP period, no correction needs to be made on the phase of a received pulse from one PRP period to the next.

A phase error between the nominal phase of the received pulse that takes a finite number of known discrete values only depending on the modulation and effective phase of the received pulse that may have slid continuously between two known nominal phases is interpreted directly (i.e. without any additional correction on the phase) firstly as an error on the global synchronization on the PRP period, and secondly on the clocks of the two orthogonal periodic functions with frequency fc.

In one advantageous embodiment, the coefficients K1 and K2 are both integers. In this case, regardless of the nominal position, there is a given phase on the received pulse for every given phase on the transmitted pulse taking a limited number of discrete values that only depend on the phase modulation. If there is no sliding of the receiver/transmitter clocks, there is no correction to be made on the phase of a received pulse. In this advantageous embodiment, the phase and position are decorrelated. The phase is read without taking account of the position.

Therefore for every nominal position, a phase error between the nominal phase and the effective phase of the received pulse that may have slid continuously between two known nominal phases is interpreted directly (without any additional correction on the phase) as being an error firstly on the global synchronization on the PRP period and on the nominal positions, and secondly on the clocks of the two orthogonal functions with frequency fp.

The coefficient K3 is a rational number. This means that coherent processing can be done in the discrete part of the receiver.

According to the invention, synchronization of the entire communication is set up and maintained by slaving a basic clock to phase sliding information Vφ output from circuit C.

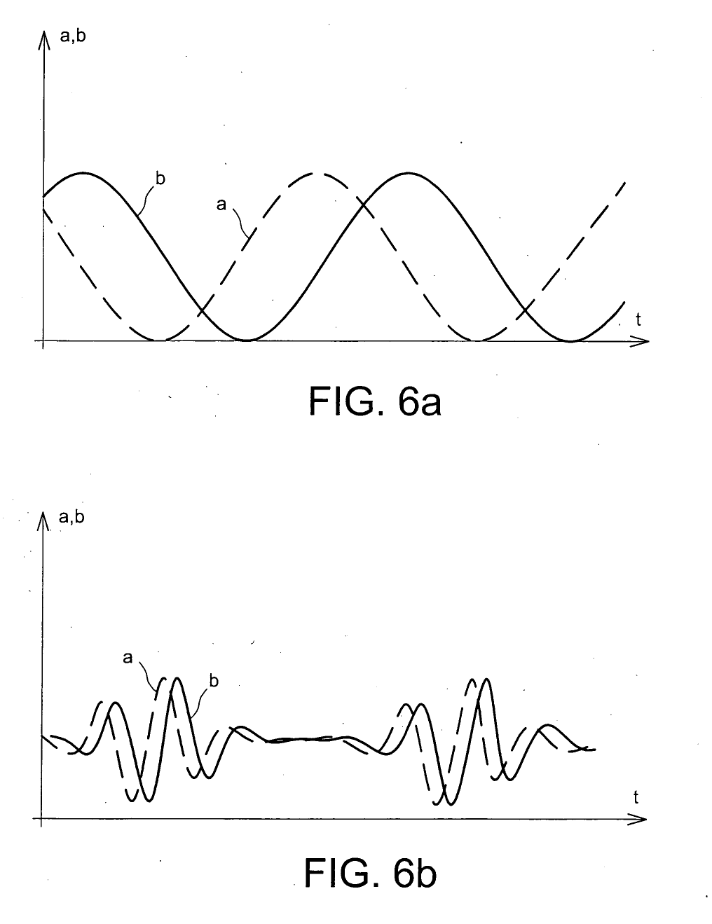

FIG. 5 shows a time discretization circuit 7 acting on the received signal R(t). The circuit 7 comprises two mixers 11, 12, a periodic function generator 13, a phase shifter 14, two low-pass filters 15, 16 and two samplers 17, 18. The periodic function generator 13 and the phase shifter 14 may be replaced by a single circuit that directly generates a doublet of orthogonal periodic functions. According to one particular embodiment of the invention, the periodic function generator 13 or the single circuit that directly generates a doublet of orthogonal periodic functions, is used as a local oscillator for the basic reception clock.

The received signal R(t) consists of a sequence of pulses. Its passband B is very wide, for example 7 GHz, and its central frequency fc is high, for example 7 GHz. The mixer 11 receives the signal R(t) on a first input, and a periodic signal a on a second input output by the generator 13. Similarly, the mixer 12 receives the signal R(t) on a first input, and a periodic signal b identical to signal a but with a phase shift from signal a on a second input, for example delayed by a duration equal to ¼fc, so as to maintain the two signals a and b orthogonal to each other. Therefore in the case of sinusoidal signals a and b, the angular phase shift is equal to π/2.

The signals output by mixers 11 and 12 are transmitted to the corresponding low-pass filters 15 and 16. The cutoff frequency of filters 15 and 16 is equal to approximately half the passband B of the signal R(t). Signals output from filters 15 and 16 are then sampled by the corresponding samplers 17 and 18 under the action of controls Cl and C2. The signal output from circuit 7 is a data stream d(k) of discrete values with two dimensions X(k), Y(k) (k=0, 1, . . . , n). The data stream d(k) corresponds to the sequence of received physical frames, that may overlap. According to one alternative embodiment of circuit 7, sampling is done before mixing.

Signals may be sampled periodically, at a period T. Advantageously, the sampling frequency is adapted to the working band using the Nyquist criterion, which enables a significant reduction in calculation times. Sampling may be semi-periodic (the time between two successive samples is then a multiple of T) or non-periodic (sampling instants then satisfy a non-periodic set value over a continuous time scale).

Advantageously, the pulse response of low pass filters 15 and 16 that integrate the analogue signal in the useful frequency band before sampling may be adapted to the shape of the received pulse. Filters 15 and 16 may also be equalizer type filters over the envelope of the spectrum to minimize spreading of the pulse response of the channel.

The width of the read window and the shape of the doublet of functions a and b will be chosen appropriately, firstly to approach a bijective transformation to eliminate as many ambiguities as possible on the detected information (there is one and only one complex point (X(k); Y(k)) that corresponds to a received pulse position), and secondly to improve the signal to noise ratio.

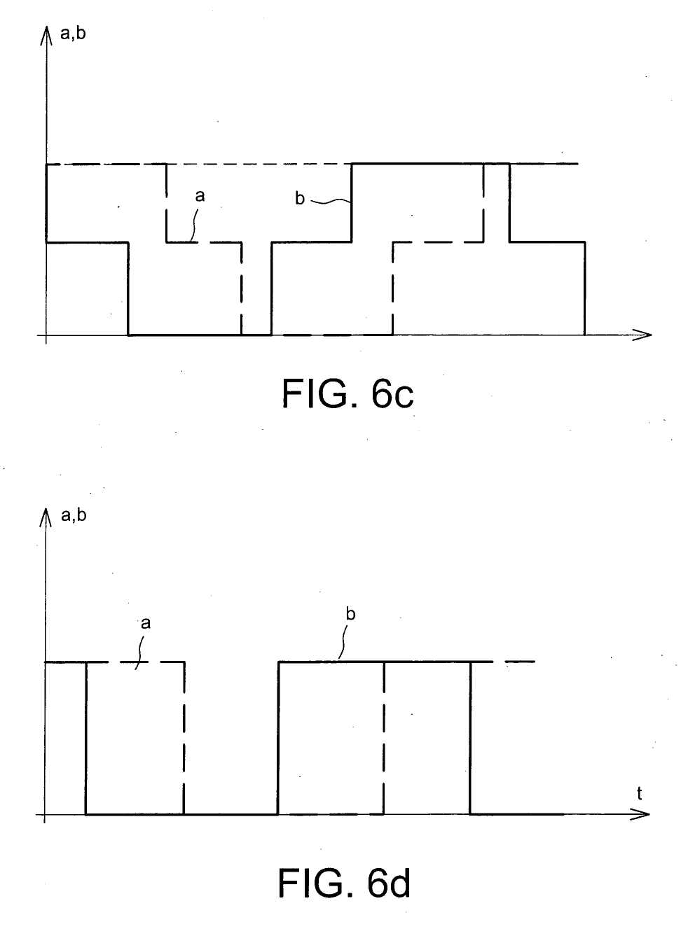

Thus, to improve the signal to noise ratio, it is useful to use a doublet of functions a and b with a shape adapted to the shape of the received pulses. This adaptation is done better if the spectra of the received signal R(t) and the signals a and b of the doublet after low-pass filtering coincide as well as possible. For example, a cosine and a sine with frequencies equal to fc, the central frequency of the received signal R(t), perform this adaptation (see FIG. 6a). Other examples of signals a and b are also possible, namely:
a signal with frequency fc having a shape similar to the shape of the received pulses and the associated quadrature signal (see FIG. 6b),
a square signal with frequency fc and the associated quadrature signal (see FIGS. 6c, 6d).

In general, the sampling frequency of circuit 7 at samplers 17 and 18 is greater than or equal to the frequency respecting the Nyquist criterion. Specifically, the Nyquist frequency in this case is equal to twice the cutoff frequency of the low pass filters 15 and 16 located on the input side of sampling.

However, according to one particular embodiment of the invention, the sampling frequency of the circuit 7 at the samplers 17 and 18 may be chosen to be less than the frequency respecting the Nyquist criterion. For example, it may thus be equal to half the Nyquist frequency. In this case, the duration of the sampling window is equal to the width of a pulse. The result is a slight degradation in performances, while relaxing constraints on the complexity of the calculations since the output side working frequency is lower.

One possible embodiment of the discretization circuit 7 is an I/Q (In phase/Quadrature) receiver. Another type of embodiment may for example be a digital implementation of the mix (multiplication of the received signal by a doublet of orthogonal functions) or the use of a circuit combining mixing and sampling functions on the same front.

The information output by the signal discretization circuit 7 is transmitted firstly to the pulse response estimating circuit 8 and secondly to the comparison circuit 9.

The circuit 8 calculates a reference signal starting from samples output from signal 7. A reference sample Xr(k), Yr(k) is then calculated for each sample X(k), Y(k). For example, one means of calculating the reference signal is to calculate an average of the samples of the successive physical frames.

The comparison circuit 9 compares the discretized received signal d(k) with the reference signal ref(k) in order to extract position and amplitude information on the transmitted symbols from the signal d(k). This comparison may be a correlation on the two components of each data d(k), frame by frame or sample by sample.

The circuit 9 may be used analogically or digitally. In one preferred embodiment, the use is digital (SCAL/VECT or,CORDIC) and analogue/digital converters are then placed between the discretization circuit 7 or the decoding and integration circuit 10, and the pulse response estimating circuit 8 and the comparison circuit 9.

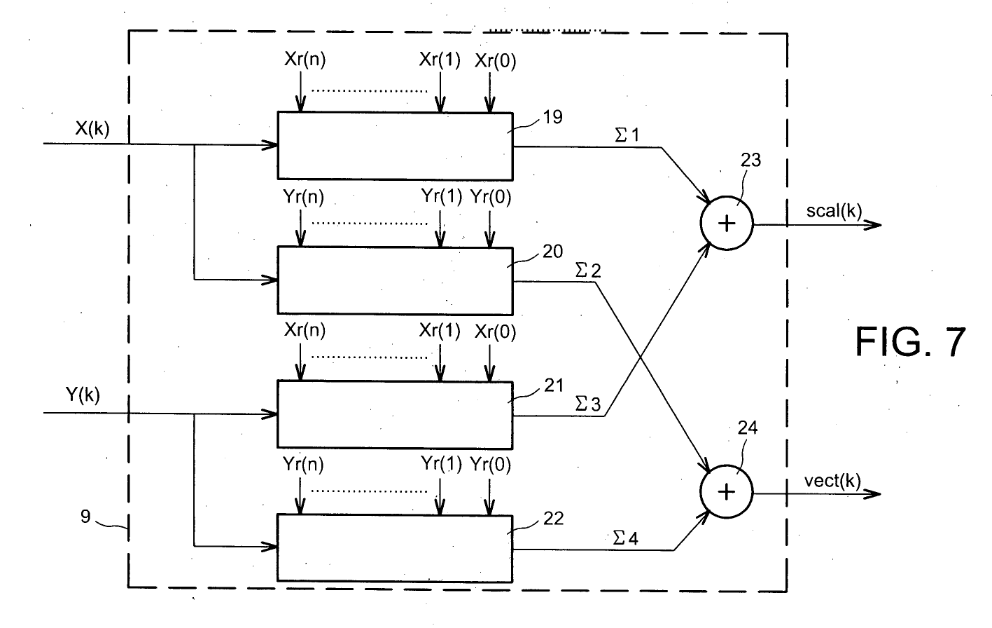

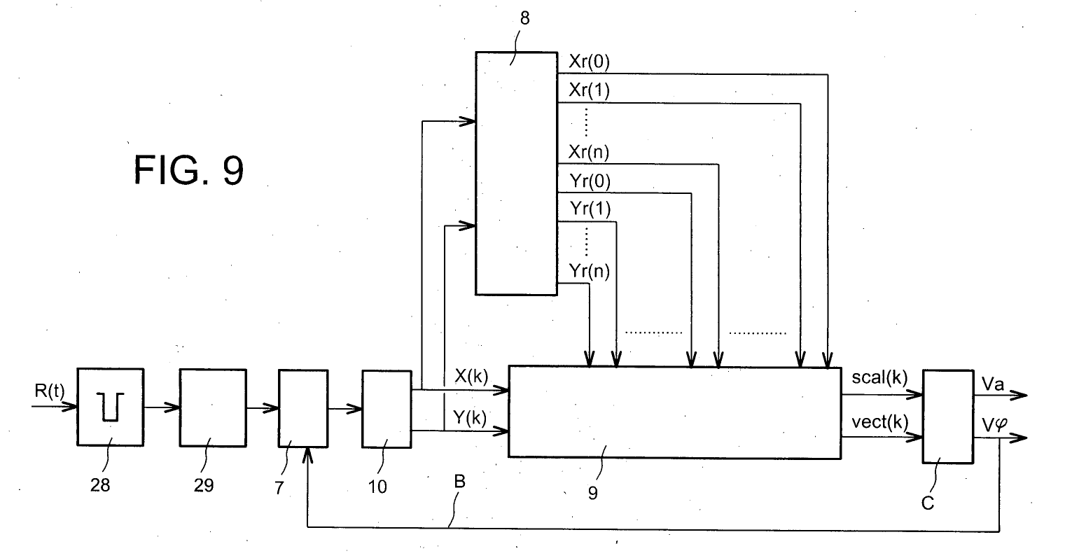

FIG. 7 shows a comparison circuit according to the invention and FIG. 8 shows a detailed view of the circuit shown in FIG. 7.

The comparison circuit 9 includes two filter banks 19 and 20 for component X(k), and two filter banks 21 and 22 for component Y(k).

Each filter bank comprises n delay circuits R(0), R(1), . . . , R(n−1), n+1 multipliers M(0), M(1); . . . , M(n) and an adder 25 (see FIG. 8). The coefficients of the pulse response filters of filter banks 19 and 21 are formed from reference data Xr(0), Xr(1), . . . , Xr(n) and coefficients of pulse response filters of filter banks 20 and 22 are formed from reference data Yr(0), Yr(1), . . . , and Yr(n). The outputs from filter banks 19 and 21 are connected to the inputs of an adder 23 and the outputs from filter banks 20 and 22 are connected to the inputs of an adder 24. The outputs from adders 23 and 24 form the outputs from the comparison circuit. The duration of each delay is equal to the sampling period T. The data obtained at the output from the filter banks 19, 20, 21 and 22 are then written as follows, respectively:
Σ₁=Σⁿᵢ₌₀Xr(i)×X(i+k),
Σ₂=Σⁿᵢ₌₀Xr(i)×Y(i+k),
Σ₃=Σⁿᵢ₌₀Yr(i)×X(i+k),
Σ₄=Σⁿᵢ₌₀Yr(i)×Y(i+k),
where the symbol × represents the multiplication operation.

Similarly, signals output by the comparison circuit 9 are then:
scal(k)=Σ₁+Σ₃, and
vect(k)=Σ₂−Σ₄

The signals scal(k) and vect(k) can be used directly for calculating the amplitude and the phase of the received signals.

If the comparison circuit is used to its full calculation capacity, each filter bank performs 2n multiplications per period T. However, it is possible to reduce the quantity of calculations, for example by activating only a fraction of the four correlations, or by activating only some of the filter coefficients (for example those that are considered to be sufficiently significant), or by making a correlation only on a fraction of the positions.

Another method of making the comparison is to use a special circuit that transforms Cartesian coordinates in the complex signal into polar coordinates and makes comparisons on phases and amplitudes.

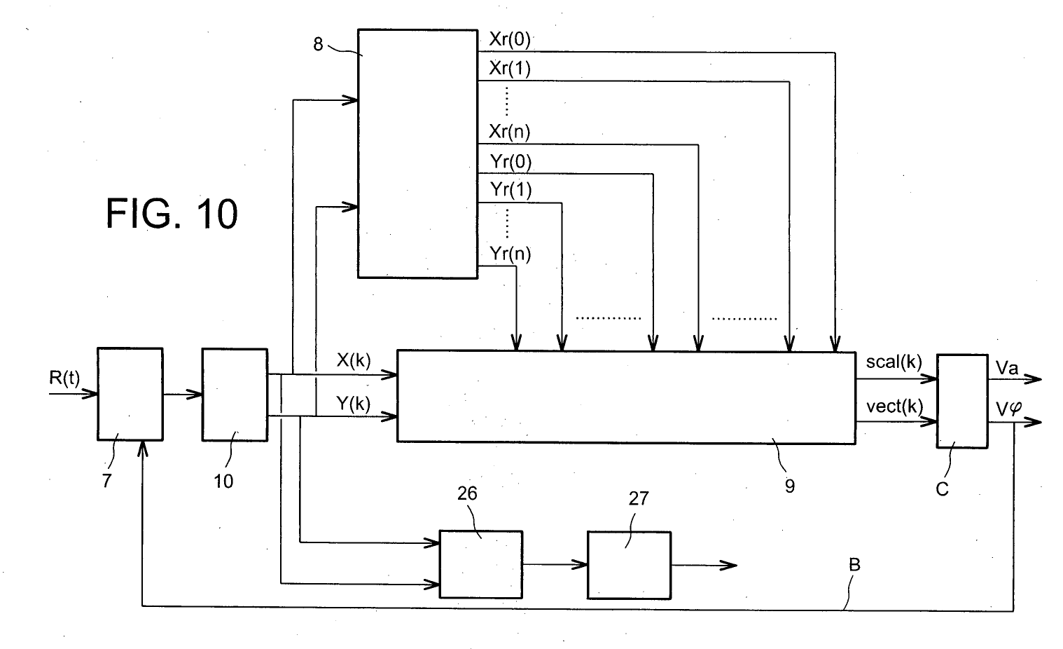

FIG. 9 shows a first improvement to the reception device according to the invention.

The device in FIG. 9, apart from the elements described above, includes means of increasing its robustness with regard to ambient noise and more particularly with regard to disturbing signals for which frequencies are included within the passband B of the received useful signal.

Disturbing signals, for which frequencies are included within the passband B of the received signal, can be picked up by the reception circuit. If the frequencies of these disturbing signals are approximately identical to the frequencies of the periodic signals used for the projection, they are amplified while mixing with the periodic signals (mixers 11 and 12 in FIG. 5). The result is a severe limitation to the Signal to Noise and Interference Ratio (SNIR).

It must be possible to eliminate the disturbing signals. The device according to the improvement to the invention eliminates these signals in a simple manner. The disturbing signals are eliminated using a band cutoff filter 28 on the input side of the radio-frequency reception front 29, itself located on the input side of the signal discretization circuit 7 (see FIG. 9). It is then possible to eliminate a signal at the central frequency fc of the received signal in a very innovative manner, while maintaining excellent global detection performances.

According to one advantageous embodiment of the invention, the central frequency of the band cutoff filter 28 can be controlled by the same control circuit that controls the frequency of the projection signals (signals a and b in the case in which N=2). It is also possible to use several band cutoff filters that operate at different frequencies to eliminate disturbing signals centered on these different frequencies.

FIG. 10 shows another improvement to a reception device according to the invention.

Apart from circuits 7, 8, 9, 10 described above, the reception device includes a signal detection circuit 26 and a decision stage 27 in series with the detection circuit 26. The circuits 26 and 27 are used during the initialization phase of the communication between a transmitting source and the receiver. The objective is then to determine whether or not the receiver detects a useful signal.

The circuit 26 achieves this by calculating a norm starting from magnitudes X(k) and Y(k) that it receives on its inputs. For example, the norm may be the quantity X(k)²+Y(k)² calculated on at least one sample or the quantity max[X(k), Y(k)] calculated on each sample. Depending on the value of the norm, a decision is made about whether or not the detected signal should be considered as being a useful signal, and consequently whether or not the received signals should be processed. It is an advantage of the device according to the invention that it enables use of the initialization phase of the transmission using a simple norm calculation circuit.

However, note that circuits 8 and 9 mentioned above can also be used to calculate the norm X(k)²+Y(k)². If circuits 8 and 9 are chosen to make this calculation, calculation resources are shared between detection of the useful signal and calculation of the norm. However, the norm will preferably be calculated by an independent circuit 26, since such a circuit is capable of making the calculation simply and quickly.

1. Receiver of an ultra wide band signal (R(t)) composed of a sequence of pulses, the receiver including means (7, 8, 9, C) of outputting amplitude information (Va) and/or phase information (Vφ) related to the received pulses, by correlation of the received signal (R(t)) with a reference signal (ref (k)), characterized in that the said means (7, 8, 9, C) comprise:
means (11, 12, 13, 14) of outputting two orthogonal signals by projection of the received signal (R(t)) onto two periodic orthogonal functions (a, b) with frequency fp approximately equal to the central frequency fc of the received signal,
means (17, 18) of sampling the two orthogonal signals to output a discrete data stream (d(k)), each discrete data having two components (X(k), Y(k)),
estimating means (8) for calculating the reference signal (ref (k)) starting from the discrete data stream (d(k)), and
comparison means (9, C) that output amplitude information (Va) and/or phase information (Vφ) related to received pulses by comparing all or some of the data contained in the discrete data stream (d(k)) with all or part of a set of data (Xr(0), Xr(1), . . . , Xr(n), Yr(0), Yr(1), . . . , Yr(n)) forming the reference signal (ref (k)).

2. Receiver according to claim 1, characterized in that it comprises a coherent decoding and integration circuit (10) to reduce discrete data (d(k)) noise output by the sampling means (17, 18).

3. Receiver according to claim 1, characterized in that the comparison means (9) include finite pulse response filter banks (19, 20, 21, 22) for which the coefficients are data that form the reference signal (ref (k)).

4. Receiver according to claim 1, characterized in that it comprises low pass filters (15, 16) placed between the means (11, 12) of outputting the two orthogonal signals and sampling means (17, 18), and for which the cutoff frequency is equal to approximately half the band width of the received signal (R(t)).

5. Receiver according to claim 4, characterized in that the low pass filters (15, 16) are equalizer filters.

6. Receiver according to claim 1, characterized in that the sampling frequency of the sampling means (17, 18) is equal to approximately fp/K3, where K3 is a rational number.

7. Receiver according to claim 1, characterized in that the sampling means (17, 18) are non-periodically controlled.

8. Receiver according to claim 1, characterized in that the estimating means (8) for calculating the reference signal (ref (k)) calculate a coherent average on the physical frames of the received signal.

9. Receiver according to claim 1, characterized in that it comprises at least one band cutoff filter (28) placed on the input side of the means (11, 12) of outputting the two orthogonal signals and for which the central frequency is within the passband (B) of the received signal (R(t)).

10. Receiver according to claim 9, characterized in that at least one band cutoff filter (28) is centered on the central frequency fc of the received signal.

11. Receiver according to claim 1, characterized in that it comprises a signal detection circuit (26) that calculates a norm with at least one discrete data (d(k)) and a decision stage (27) mounted in series with the detection circuit to decide whether or not to process the received signal associated with the discrete data.

12. Receiver according to claim 11, characterized in that the norm is equal to the square of the modulus of the two components (X(k), Y(k)) of the discrete data.

13. Receiver according to claim 11, characterized in that the norm is equal to the maximum of the two components (X(k), Y(k)) of the discrete data.

14. Receiver according to claim 1, characterized in that it comprises a slaving loop (B) that transmits phase information (Vφ) as the control signal for a receiver clock circuit.

15. Receiver according to claim 14, characterized in that the receiver clock circuit outputs the two periodic orthogonal functions (a, b) with frequency fp.

16. Ultra wide band transmission system comprising a transmitter that transmits pulse sequences, a receiver and a transmission channel between the transmitter and the receiver, characterized in that the receiver is a receiver according to any one of claims 1 to 15.

17. Ultra wide band transmission system according to claim 16, characterized in that the average period of the transmitted pulses is equal to K1/fp, where K1 is a real number.

18. Ultra wide band transmission system according to claim 17, characterized in that K1 is an integer number greater than or equal to 1.

19. Ultra wide band transmission system according to claim 16, characterized in that the time base for the position modulation of the transmitted pulses is equal to approximately K2/fp, where K2 is a real number.

20. Ultra wide band transmission system according to claim 19, characterized in that K2 is an integer number greater than or equal to 1.

21. Method for reception of an ultra wide band signal (R(t)) composed of a sequence of pulses, the method being used to output amplitude information (Va) and/or phase information (Vφ) related to received pulses, by correlation of the received signal (R(t)) with a reference signal (ref(k)), characterized in that it includes:
a projection step (11, 12, 13, 14) projecting the received signal (R(t)) on two periodic orthogonal functions (a, b) with frequency fp equal to approximately the central frequency fc of the received signal, to output two orthogonal signals,
a sampling step (17, 18) for the two orthogonal signals to output a discrete data stream (d(k)), each discrete data having two components (X(k), Y(k)),
an estimating step (8) to calculate the reference signal (ref(k)) from the discrete data stream (d(k)), and
a comparison step (9, C) that outputs amplitude information (Va) and/or phase information (Vφ) related to received pulses by comparison of all or some of the data contained in the discrete data stream (d(k)) with all or some of a set of data (Xr(0), Xr(1), . . . , Xr(n), Yr(0), Yr(1), . . . , Yr(n)) forming the reference signal (ref(k)).

22. Method according to claim 21, characterized in that it comprises a coherent decoding and integration step (10) to reduce the noise of discrete data (X(k)), Y(k)) output from the sampling step.

23. Method according to claim 21, characterized in that it includes a low pass filtering step (15, 16) of the two orthogonal signals, the filter bandwidth being equal to approximately the bandwidth (B) of the ultra wide band signal (R(t)).

24. Method according to claim 21, characterized in that sampling is done at a sampling frequency equal to approximately fp/k3, where K3 is a rational number.

25. Method according to claim 21, characterized in that sampling is non-periodic.

26. Method according to claim 21, characterized in that during the estimating step, the reference signal is calculated in the form of a coherent average on physical frames of the ultra wide band signal (R(t)).

27. Method according to claim 21, characterized in that it includes band cutoff filtering (28) of the ultra wide band signal centered on the frequency fc of the received signal.

28. Method according to claim 27, characterized in that the central frequency of the band cutoff filtering is controlled by a control circuit that controls the frequency of the two periodic orthogonal functions.

29. Method according to claim 21, characterized in that it includes the calculation of a norm for at least one discrete data with two dimensions of a received signal and a decision step to decide whether or not the received signal associated with the discrete data should be processed.

30. Method according to claim 21, characterized in that it includes a step to slave a clock circuit of the receiver using phase information (Vφ).

31. Method for transmission of an ultra wide band signal including a method for transmitting pulse sequences and a method for receiving transmitted pulses, characterized in that the method for reception of transmitted pulses is a method according to any one of claims 21 to 30.

32. Method for transmission of an ultra wide band signal according to claim 31, characterized in that the average period of transmitted pulses is equal to K1/fp, where K1 is a real number.

33. Method for transmission of an ultra wide band signal according to claim 32, characterized in that K1 is an integer number greater than or equal to 1.

34. Method for transmission of an ultra wide band signal according to claim 31, characterized in that the time base for position modulation of transmitted pulses is equal to approximately K2/fp, where K2 is a positive real number.

35. Method for transmission of an ultra wide band signal according to claim 34, characterized in that K2 is an integer number greater than or equal to 1.
